(19) United States
(12) Patent Application Publication
(10) Pub. No.: US 2013/0093675 A1
(43) Pub. Date: Apr. 18, 2013

(54) Remote controllable image display system, controller, and processing method therefor

(71) Applicants: Chun-Huang Lin, HsinChu City (TW); Chieh-Hsiung Chang, HsinChu City (TW); Hao-Ming Hsu, HsinChu City (TW)

(72) Inventors: Chun-Huang Lin, HsinChu City (TW); Chieh-Hsiung Chang, HsinChu City (TW); Hao-Ming Hsu, HsinChu City (TW)

(73) Assignee: Chip Goal Electronics Corporation, R.O.C.

(21) Appl. No.: 13/373,509

(22) Filed: Nov. 16, 2011

(30) Foreign Application Priority Data
Jul. 26, 2011 (TW) 100126483

(51) Int. Cl. G06F 3/033

(52) U.S. Cl. CPC G06F 3/033
USPC 345/158

(57) ABSTRACT

The present invention discloses a remote controllable image display system, and a controller and a motion detection method for use in the system. The system includes: an image display showing images generated by a program; a light source generating at least a light beam; a controller controlling a current image according to its displacement or rotation and including at least one image sensor sensing the light beam to obtain a first frame having at least two light spots; a processor obtaining a first angle between a main operation surface of the controller and a basis plane according to the differences between the coordinates of the two light spots in the first frame.

### CROSS REFERENCE

The present invention claims priority to TW 100126483, filed on Jul. 26, 2011.

### BACKGROUND OF THE INVENTION

1. Field of Invention

The present invention relates to a remote controllable image display system, and a controller and a processing method therefor; in particular, the present invention relates to such remote controllable image display system, controller and processing method which are capable of determining a position or a rotation of the controller by means of an image sensor.

2. Description of Related Art

Conventional remote controllers of image display systems (TVs, video recorders and so on) are merely capable of inputting simple instructions, such as power-on, power-off, channel change, and volume tuning, etc. to their corresponding image player hosts, but cannot act as a computer mouse to arbitrarily move a cursor on a screen, for example to select a certain icon on a screen for executing a corresponding function or program. Therefore, such conventional remote controllers cannot be used as a tool for controlling functions relating to Internet connection or for playing a video game. On the other hand, although a wireless mouse can be used as a tool for controlling functions relating to Internet connection or for playing a video game, it can not output an instruction by its rotation, and therefore a user can not use it to intuitively output a rotation instruction, for example for rotating an image (such as for browsing photographs) or controlling the rotation of an object in a video game. In addition, the wireless mouse needs to be placed on a table, otherwise it cannot effectively function; hence, it is not suitable for use in an interactive video game system which requires producing/sensing various actions.

In current interactive video game systems, joysticks or remote controllers are often necessary for users to play the games by actions, e.g. to drive a race car, to swing a golf club, etc. Such joystick or remote controller typically includes a gyro, an accelerometer, or an image sensor. In a joystick or remote controller which employs the gyro and the accelerometer, the rotation of the joystick or remote controller can be detected by the cooperation of the gyro and the accelerometer. However, the resolutions of these two sensing devices are insufficient for recognizing a fine or slow action. Furthermore, they have relatively high costs such that the price of the joystick or remote controller cannot be reduced.

In the joystick or remote controller which employs the image sensor to sense images and thereby control a cursor on a screen or select a certain icon on the screen for executing a corresponding function or program, although the resolution of the image sensor is better than that of the gyro and the accelerometer, the image sensor cannot detect the rotation of the joystick or remote controller by the user; such rotation for example may be a rotation action or a rotation instruction, such as fine tuning a quasi-analog knob.

FIGS. 1A-1B are schematic diagrams illustrating the use of a joystick employing an image sensor in a prior art interactive video game system. An image sensor 111 in a joystick 11 captures images which contain light spots emitted from lighting units 131 of a light source 13, and a relative position of the joystick 11 is determined according to the images. The light spots emitted from lighting units 131 overlap to become one big spot in the captured image, and the overlapping single light spot cannot be used to detect rotation. In addition, if the user holds the joystick 11 in a way which is not consistent with the coordinate system of the image sensor 111, the moving direction of the joystick would be wrongly detected due to the uncorrected coordinates of the image sensor 111, and what is to be controlled, such as a cursor 141 on the screen 14, will move along an incorrect direction. More specifically, in FIG. 1A, because the user holds the joystick 11 in a way which is consistent with the coordinate system of the image sensor 111, the rightward movement of the joystick 11 is correctly detected by the image sensor 111, and the cursor 141 correctly moves from the left side to the right side on the screen 14. However, when the user holds the joystick 11 in a way which is not consistent with the coordinate system of the image sensor 111, the same rightward movement of the joystick 11 causes the cursor 141 to move along a different direction, as shown in FIG. 1B. In FIG. 1B, the main surface 112 (with buttons 113 thereon) of the joystick 11 faces right (with a clockwise rotation by an angle θ relative to the main surface in FIG. 1A), so the rightward movement of the joystick 11 is detected as an upward movement by the image sensor 111 Accordingly, the cursor 141 incorrectly moves from the lower side of the screen 14 to the upper side.

In view of above, the present invention overcomes the foregoing drawbacks by providing a remote controllable image display system, a controller, and a processing method, wherein the coordinate system of the image sensor of the joystick or remote controller is effectively calibrated and the image sensor is capable of correctly detecting the rotation of the joystick or remote controller.

### SUMMARY OF THE INVENTION

An objective of the present invention is to provide a remote controllable image display system.

Another objective of the present invention is to provide a controller of a remote controllable image display system.

Another objective of the present invention is to provide a processing method for a remote controllable image display system.

To achieve the foregoing objectives, in one aspect, the present invention provides a remote controllable image display system which comprises: an image display showing images generated by a program; a light source generating at least a light beam; a controller controlling a current image according to displacement or rotation of the controller, the controller including at least one image sensor sensing the light beam to obtain a first frame having at least two light spots; and a processor obtaining a first angle between a main operation surface of the controller and a basis plane according to differences between coordinates of the two light spots in the first frame.

In the foregoing remote controllable image display system, preferably, the displacement or the rotation of the controller is transferred to a displacement instruction or a rotation instruction to the current image.

In the foregoing remote controllable image display system, preferably, the displacement instruction adjusts a moving direction according to the first angle.

In the foregoing remote controllable image display system, preferably, the image sensor captures a second frame having the two light spots, and the processor obtains a second angle between the main operation surface and the basis plane from the second frame, whereby the rotation instruction is generated according to the first angle and the second angle.

In one embodiment of the foregoing remote controllable image display system, the light source includes two lighting units each emitting a light beam, and the controller includes one image sensor to receive the light beams.

In another embodiment of the foregoing remote controllable image display system, the light source includes one lighting unit, and the controller includes two image sensors to receive the light beam; the first frame is obtained by superposing two frames captured by the two image sensors.

In the foregoing remote controllable image display system, preferably, execution of the rotation instruction is started by a trigger mechanism.

In one embodiment of the foregoing remote controllable image display system, the rotation instruction changes a rotation angle or a rotation speed of the current image or an object in the current image.

In yet another aspect, the present invention provides a controller of a remote controllable image display system, the controller receiving at least one light beam generated by the system and controlling an image shown by the system according to displacement or rotation of the controller. The controller comprises: at least one image sensor sensing the light beam to obtain a first frame having at least two light spots; and a processor obtaining a first angle between a main operation surface of the controller and a basis plane according to differences between coordinates of the two light spots in the first frame.

In yet another aspect, the present invention provides a processing method for a remote controllable image display system, the method processing an action instruction on an image, the action instruction being generated by displacement or rotation of a controller of the system. The method comprises: receiving at least one light beam generated by the system; obtaining a first frame having at least two light spots according to the light beam; and obtaining a first angle between a main operation surface of the controller and a basis plane according to differences between coordinates of the two light spots in the first frame.

In the foregoing processing method, preferably, the rotation instruction provides one or more of the following functions: changing a rotation angle or a rotation speed of the image or an object in the image; scrolling, switching, magnifying, shrinking, or rotating the image or the object in the image; or adjusting a volume or a playing speed corresponding to the image.

The objectives, technical details, features, and effects of the present invention will be better understood with regard to the detailed description of the embodiments below, with reference to the drawings.

### BRIEF DESCRIPTION OF THE DRAWINGS

FIGS. 1A-1B show are schematic diagrams illustrating the use of a joystick employing an image sensor in a prior art interactive video game system.

FIG. 2 shows a schematic diagram illustrating a wireless remote control image display system of the present invention.

FIG. 3 shows a schematic diagram of another embodiment of the present invention, illustrating a wireless remote control image display system.

FIG. 4 shows a schematic diagram illustrating how the present invention processes the light spots according to one embodiment.

FIG. 5 shows a schematic diagram of another embodiment of the present invention, illustrating how the present invention processes the light spots.

### DESCRIPTION OF THE PREFERRED EMBODIMENTS

In the following description, embodiments of the present invention will be described by taking an interactive video game system as an example, but it should be noted that the present invention is applicable to other types of video or interactive systems such as for remote-control of a video player, remote-control of a smart TV, browsing homepages on the Internet, etc.

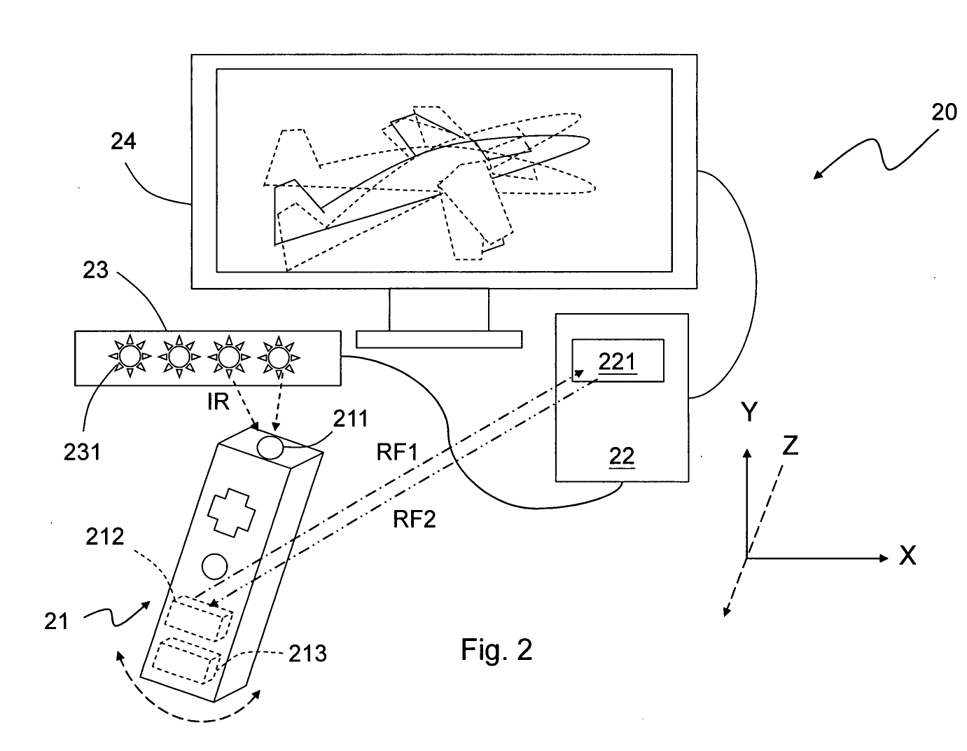

FIG. 2 shows a schematic diagram illustrating a wireless remote control image display system of the present invention. As shown in this figure, the wireless remote control image display system 20 basically comprises a controller 21, a game host 22, a light source 23, and an image screen 24. The game host 22 executes a video game program which is displayed by the image screen 24. The image screen 24 may be an image display, a projector, a head-mounted display, or other types of display apparatuses. A user operates the controller 21 to interact with the game host 22 such that the game host 22 executes various actions or instructions. During operating the controller, the user may rotate the controller to generate an action (such as controlling an object in an image displayed on the screen, referred to as a rotation action hereinafter) or an instruction (such as tuning a quasi-analog knob, referred to as a rotation instruction hereinafter). Shown in this embodiment is that the user is rotating an airplane on the image screen 24. The rotation action and the rotation instruction are collectively referred to as rotation functions.

The light source 23 includes lighting units 231 which emit light such as infrared rays; as the user operates the controller 21, the emitted light is received by the image sensor 211 of the controller 21. In this embodiment of the present invention, there are multiple lighting units 231 and one CMOS image sensor chip; the lighting units 231 are arranged so that an image frame captured by the image sensor 211 includes at least two light spots which can be distinguished from one the other. A processor 213 calculates the rotation according to the changes in the positions of the at least two light spots. The processor 213 can be disposed in the controller 21 (as in this embodiment), or can be disposed in the game host 22 in another embodiment. The game host 22 includes a transceiver 221, which communicates with the transceiver 212 of the controller 21 through the radio frequency signals RF1 and RF2 (or IR) for bidirectional data transmission.

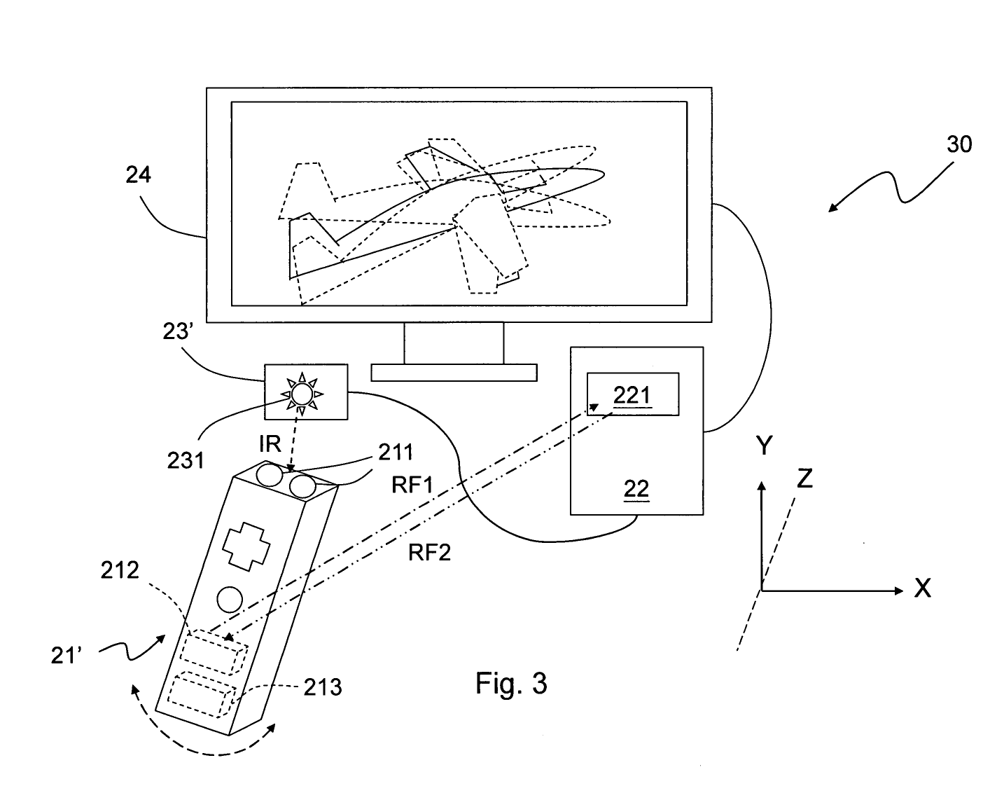

FIG. 3 shows another embodiment wherein, different from the embodiment of FIG. 2, the light source 23′ of the wireless remote control image display system 30 has only one light unit 231, but the controller 21′ has two image sensors 211. The two image frames respectively captured by the two image sensors 211 are superposed, and the superposed image frame include two separated light spots. The two light spots in the image frame obtained in this manner can provide the same effect as the two light spots obtained by the embodiment of FIG. 2. Therefore, in the following description, an image frame having two light spots can be obtained by either manner of FIG. 2 or FIG. 3.

Coordinate Calibration

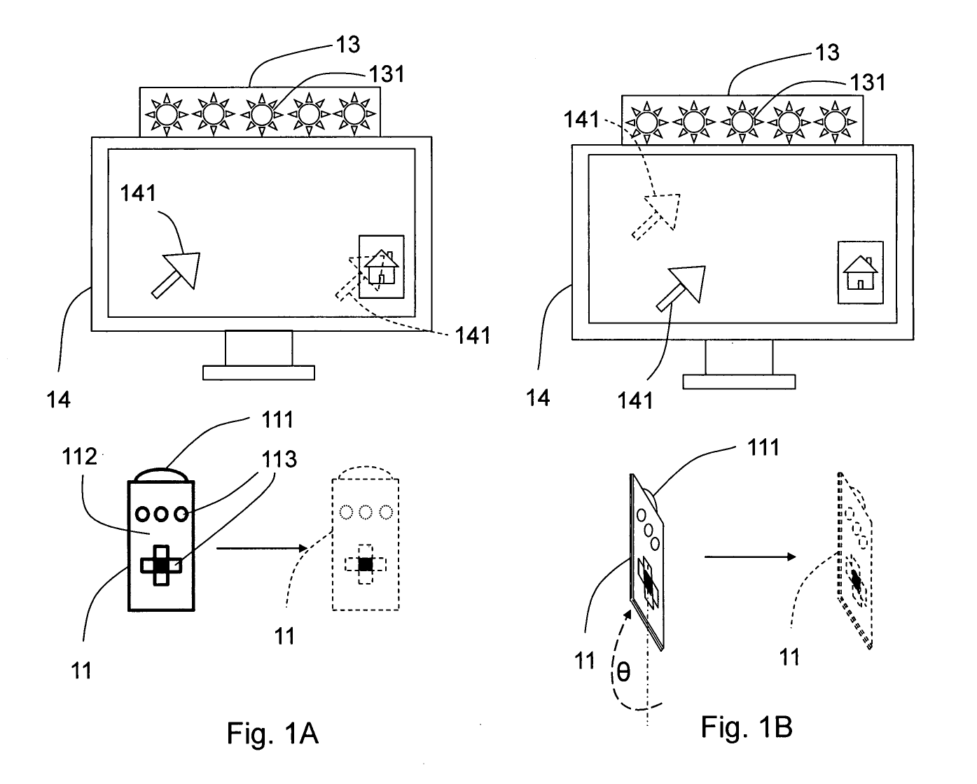

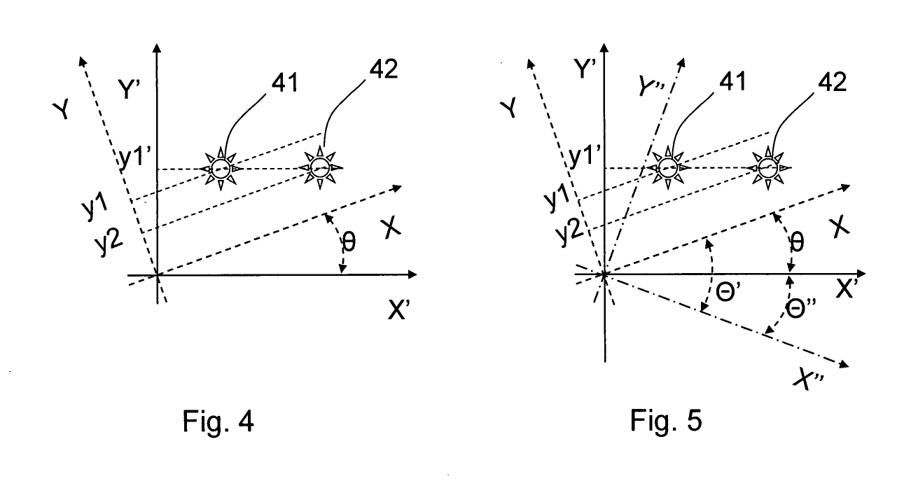

Because there are at least two light spots, the present invention can determine how the controller is held and compensate the rotation offset angle due to the gesture of the user's hand holding the controller; as a result, the wrong movement of the cursor in the prior art as shown in FIG. 1B can be avoided. Referring to FIG. 4, when the user holds the controller 21 or 21′ in the way as shown in FIG. 1B, that is, the main surface of the controller is rotated counterclockwise by an offset angle θ from the horizontal axis), the light spots 41 and 42 have different Y coordinates in the current XY coordinate, that is, y1 and y2, and thus it can be determined that the main surface of the current controller is not horizontal. According to the coordinates of the light spots 41 and 42 located in the current XY coordinate system, the processor 213 determines that the XY coordinate system needs to be rotated clockwise by an offset angle θ to obtain the X′Y′ coordinate system of the image sensor 211 wherein the light spots 41 and 42 have the same Y coordinate (equal to y1′). When the user intends to move the cursor rightward as shown in FIG. 1A while keeping the main surface rotated by the offset angle θ, the present invention can calibrate the XY coordinate system as shown in FIG. 4 to be the X′Y′ coordinate system, so the cursor can be moved along the direction that the user actually wants.

Following is an example of the detailed formulas for calibrating the coordinate system when the user holds the controller by a rotation offset angle θ, but it should be noted that the present invention is not limited to these formulas. The coordinates of the light spots 41 and 42 in the XY coordinate system are respectively (X₁, Y₁) and (X₂, Y₂); the rotation offset angle θ and the transformation between the two coordinate systems can be obtained by the following formulas:

$$θ = arctan \frac{{Y}_{2} - {Y}_{1}}{{X}_{2} - {X}_{1}} \\ [ \begin{matrix}{X}_{1}^{′} \\ {Y}_{1}^{′}\end{matrix} ] = [ \begin{matrix}cos θ & - sin θ \\ sin θ & cos θ\end{matrix} ] [ \begin{matrix}{X}_{1} \\ {Y}_{1}\end{matrix} ] \\ [ \begin{matrix}{X}_{2}^{′} \\ {Y}_{2}^{′}\end{matrix} ] = [ \begin{matrix}cos θ & - sin θ \\ sin θ & cos θ\end{matrix} ] [ \begin{matrix}{X}_{2} \\ {Y}_{2}\end{matrix} ]$$

According to the above formulas, the coordinates of the light spots 41 and 42 in the calibrated coordinate system X′Y′ can be obtained and they should be located at the same horizontal level, that is, Y₁′=Y₂′. In this manner, the coordinates of the light spot are compensated by the offset angle θ during the user's operation.

Rotation Angle Calibration

The gestures for different users to hold the controller are often different, and accordingly, when different users rotate the controller, the rotation angle of the rotation action or the rotation instruct may be wrongly detected. Let us assume that the user holds the controller 21 with the main surface rotated by an offset angle θ, and triggers the rotation function (i.e., starts a meaningful rotation of the controller 21) whereby the controller 21 is rotated clockwise by an angle θ″. Referring to FIG. 5, the controller 21 starts in the coordinate system X′Y′ and it is clockwise rotated by the rotation angle θ″ to become the coordinate system X″Y″. If the angle θ′ between the coordinate system X″Y″ and the coordinate system XY is deemed as the rotation angle of the controller 21, this is obviously not what the user wants. To solve this, the present invention calculates the offset angle θ at the time point that the rotation function is triggered according to the foregoing method, and obtains the actual desired rotation angle θ″ by θ′ minus θ.

Rotation Action or Rotation Instruction

Because there may be meaningless rotations of the controller 21 (e.g. by the gesture of the user), the rotation function (rotation action or rotation instruction) should preferably be triggered and executed only when desired. To this end, according to the present invention, one embodiment is to provide a button or a switch on the controller 21 for the user to trigger the rotation function by pressing it. Another embodiment is to provide a specific area or icon on the screen, so that when the controller 21 moves the cursor to the specific area or icon, the rotation function is triggered.

Referring to FIG. 5, if the two image frames in the coordinate system X′Y′ and the coordinate system X″Y″ are a first frame and a second frame captured by the image sensor 211 at different time points, then the rotation angle of the rotation action can be obtained from these two frames. In a preferred embodiment, the first frame and second frame can be two frames captured with a unit time interval in between. In a more sophisticated embodiment, a threshold can be set and compared with the rotation angle to determine whether there is meaningful acceleration in the rotation action. (If the rotation angle is larger than the threshold, there is meaningful acceleration and it can be determined that the user is rotating the controller to execute a rotation function. If the rotation angle is smaller than the threshold, the rotation may be meaningless.) Moreover, the rotation angle can be compared with several thresholds for multi-level determination. For example, when the rotation angle is smaller than a first threshold, such as 30 degrees, a movement of an object on the screen is displayed by a certain speed; when the rotation angle is larger than 30 degrees and smaller than a second threshold, such as 60 degrees, the movement is displayed by double speed; when the rotation angle is larger than 60 degrees, the movement is displayed by triple speed.

Applications of Rotation Action or Instruction

### 1. Web Page Browse

a. The user triggers the rotation function, for example by pressing a button on the controller, and scrolls the browsed web page upward or downward by clockwise or counterclockwise rotation.
b. The user triggers the rotation function, for example by moving a cursor to a specific position on the screen, and scrolls the browsed web page upward or downward by clockwise or counterclockwise rotation.

2. Browsing Pictures
a. The user presses a button on the controller to trigger the rotation function, and rotates the browsed picture by clockwise or counterclockwise rotation.
b. The user moves the cursor to a specific position on the screen to trigger the rotation function, and switches the browsed picture by clockwise or counterclockwise rotation.
c. The user moves the cursor to another specific position on the screen to trigger the rotation function, and magnifies or shrinks a picture by clockwise or counterclockwise rotation.

3. Listening to Music
a. The user presses a button on the controller for volume tuning, and tunes the volume of the music by clockwise or counterclockwise rotation. In a preferred embodiment, the aforementioned acceleration determination and multi-level determination can be used here.
b. The user moves the cursor to a specific position on the screen, and switches songs by clockwise or counterclockwise rotation. In a preferred embodiment, the aforementioned acceleration determination and multi-level determination can be used here to speed up the switching of the songs.

4. The rotation function can be used in a game of balance, such as maintaining the center of gravity, or, in a car race game for driving the wheel.

5. Watching TV
a. The user presses a button on the controller for volume tuning or channel selection, and tunes the volume or switches channels by clockwise or counterclockwise rotation. In a preferred embodiment, the aforementioned acceleration determination and multi-level determination can be used here to speed up the volume adjustment or channel switching.
b. The user moves the cursor to a specific position on the screen, and tunes the volume or switches channels by clockwise or counterclockwise rotation. In a preferred embodiment, the aforementioned acceleration determination and multi-level determination can be used here to speed up the volume adjustment or channel switching.

6. Seeing Movie
a. The user presses a button on the controller, and adjusts playing speed by clockwise or counterclockwise rotation. In a preferred embodiment, the aforementioned acceleration determination and multi-level determination can be used here to adjust the playing speed.
b. The user moves the cursor to a specific position on the screen, and adjusts playing speed by clockwise or counterclockwise rotation. In a preferred embodiment, the aforementioned acceleration determination and multi-level determination can be used here to adjust the playing speed.

7. Reading Electrical Book
a. The user presses a button on the controller, and scrolls the current page upward or downward, or flips it to a previous or next page, by clockwise or counterclockwise rotation.
b. The user moves the cursor to a specific position on the screen, and scrolls the read page upward or downward, or flips it to a previous or next page, by clockwise or counterclockwise rotation.
c. The user moves the cursor to another specific position on the screen, and magnifies or shrinks the current page by clockwise or counterclockwise rotation.

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention. For example, the rotation function can be triggered by other mechanisms using hardware or software. For another example, an image frame having two light spots can be obtained by one image sensor and multiple lighting units, or by superposing two image frames obtained by two image sensors from a single lighting unit, or by multiple image sensors and multiple lighting units. The applications of the rotation action or the rotation instruction are not limited to the above enumerated embodiments; the rotation action or rotation instruction can be applied to executing other functions such as screen brightness and contrast adjustments. The calibrations mentioned above can be processed by an external processor instead of the processor in the controller. Thus, the present invention should cover all such and other modifications and variations, which should be interpreted to fall within the scope of the following claims and their equivalents.

What is claimed is:

1. A remote controllable image display system, comprising:
an image display showing images generated by a program;
a light source generating at least a light beam;
a controller controlling a current image according to displacement or rotation of the controller, the controller including at least one image sensor sensing the light beam to obtain a first frame having at least two light spots; and
a processor obtaining a first angle between a main operation surface of the controller and a basis plane according to differences between coordinates of the two light spots in the first frame.

2. The remote controllable image display system of claim 1, wherein the displacement of the controller is transferred to a displacement instruction to the current image, and the rotation of the controller is transferred to a rotation instruction to the current image.

3. The remote controllable image display system of claim 2, wherein the displacement instruction adjusts a moving direction according to the first angle.

4. The remote controllable image display system of claim 2, wherein the image sensor captures a second frame having the two light spots, and the processor obtains a second angle between the main operation surface and the basis plane from the second frame, whereby the rotation instruction is generated according to the first angle and the second angle.

5. The remote controllable image display system of claim 1, wherein the light source includes two lighting units each emitting a light beam, and the controller includes one image sensor to receive the light beams.

6. The remote controllable image display system of claim 1, wherein the light source includes one lighting unit and the controller includes two image sensors to receive the light beam, and wherein the first frame is obtained by superposing two frames captured by the two image sensors.

7. The remote controllable image display system of claim 2, wherein execution of the rotation instruction is started by a trigger mechanism.

8. The remote controllable image display system of claim 2, wherein the rotation instruction changes a rotation angle or a rotation speed of the current image or an object in the current image.

9. A controller of a remote controllable image display system, the controller receiving at least one light beam generated by the system and controlling an image shown by the system according to displacement or rotation of the controller, the controller comprising:
at least one image sensor sensing the light beam to obtain a first frame having at least two light spots; and
a processor obtaining a first angle between a main operation surface of the controller and a basis plane according to differences between coordinates of the two light spots in the first frame.

10. The controller of a remote controllable image display system of claim 9, wherein the displacement of the controller is transferred to a displacement instruction to the image, and the rotation of the controller is transferred to a rotation instruction to the image.

11. The controller of a remote controllable image display system of claim 10, wherein the displacement instruction adjusts a moving direction according to the first angle.

12. The controller of a remote controllable image display system of claim 10, wherein the image sensor captures a second frame having the two light spots, and the processor obtains a second angle between the main operation surface and the basis plane from the second frame, whereby the rotation instruction is generated according to the first angle and the second angle.

13. The controller of a remote controllable image display system of claim 9, wherein the controller includes two image sensors to receive the light beam, and the first frame is obtained by superposing two frames captured by the two image sensors.

14. The controller of a remote controllable image display system of claim 10, further comprising a button or a switch for triggering execution of the rotation instruction.

15. The controller of a remote controllable image display system of claim 10, wherein the rotation instruction changes a rotation angle or a rotation speed of the image or an object in the image.

16. A processing method for a remote controllable image display system, the method processing an action instruction on an image, the action instruction being generated by displacement or rotation of a controller of the system, the method comprising:
receiving at least one light beam generated by the system;
obtaining a first frame having at least two light spots according to the light beam; and
obtaining a first angle between a main operation surface of the controller and a basis plane according to differences between coordinates of the two light spots in the first frame.

17. The processing method for a remote controllable image display system of claim 16, further comprising: transferring the displacement of the controller to a displacement instruction to the image, or transferring the rotation of the controller to a rotation instruction to the image.

18. The processing method for a remote controllable image display system of claim 17, wherein the displacement instruction adjusts a moving direction according to the first angle.

19. The processing method for a remote controllable image display system of claim 17, further comprising: capturing a second frame having the two light spots and obtaining a second angle between the main operation and the basis plane, whereby the rotation instruction is generated according to the first angle and the second angle.

20. The processing method for a remote controllable image display system of claim 17, wherein the rotation instruction provides one or more of the following functions: changing a rotation angle or a rotation speed of the image or an object in the image; scrolling, switching, magnifying, shrinking, or rotating the image or the object in the image; or adjusting a volume or a playing speed corresponding to the image.
